(19) United States
(12) Patent Application Publication
(10) Pub. No.: US 2025/0100543 A1
(43) Pub. Date: Mar. 27, 2025

(54) METHOD FOR DETERMINING A STEERING ROLL RADIUS, STEERING/BRAKING METHOD, CONTROLLER AND UTILITY VEHICLE

(71) Applicant: ZF CV Systems Global GmbH, Bern (CH)

(72) Inventors: Janik Ricke, Uetze (DE); Benjamin Bieber, Wedemark (DE); Klaus Plähn, Seelze (DE)

(21) Appl. No.: 18/975,999

(22) Filed: Dec. 10, 2024

Related U.S. Application Data
(63) Continuation of application No. PCT/EP2023/063211, filed on May 17, 2023.

(30) Foreign Application Priority Data
Jun. 14, 2022 (DE) 10 2022 114 959.5

(51) Int. Cl. B60W 30/04; B60W 10/184; B60W 10/20; B60W 60/00

(52) U.S. Cl. CPC B60W 30/04; B60W 10/184; B60W 10/20; B60W 60/0016; B60W 2510/202; B60W 2520/18; B60W 2530/20

(57) ABSTRACT

A method is for determining a steering roll radius of a vehicle. The method includes the following steps: during a journey, initiating an asymmetrical braking maneuver on a steered axle of the vehicle, in which a first braking force is supplied to a first wheel of the steered axle, which is greater than a second braking force supplied to the other wheel of the steered axle, during the braking maneuver, detecting a steering command signal input from the driver or a vehicle system and a steering torque applied to the wheels of the braked axle, evaluating the asymmetrical braking maneuver as a function of determined data, determining at least a sign of the steering roll radius of at least the first wheel as a function of the evaluation.

### CROSS-REFERENCE TO RELATED APPLICATIONS

This application is a continuation application of international patent application PCT/EP2023/063211, filed May 17, 2023, designating the United States and claiming priority from German application 10 2022 114 959.5, filed Jun. 14, 2022, and the entire content of both applications is incorporated herein by reference.

### TECHNICAL FIELD

The disclosure relates to a method for determining a steering roll radius. Furthermore, a method for steering braking using this method, a control device and a commercial vehicle are provided.

### BACKGROUND

The steering roll radius is defined as the distance between the intersection of the pivot axis of a vehicle wheel and the road surface and the center of the tire contact area of the vehicle wheel on the road surface. Depending on the steering roll radius, steering torques are exerted on the vehicle wheel during braking. In the case of wheels on a steered axle, in particular the front axle, a steering maneuver may thus be effected.

With a positive steering roll radius, as is often the case with commercial vehicles, the right front wheel is braked more than the left front wheel, for example, in order to turn the steering to the right. In vehicles with a negative steering roll radius, the opposite vehicle wheel must be braked more heavily.

Using the brake for a steering function is described, for example, in U.S. Pat. Nos. 6,076,626, 6,279,674, DE 10 2006 046 497 A, EP 2998175 B1, EP 3293064 A1 and EP 3293065 A1.

US 2013/0116969 describes how to steer a vehicle wheel to different positions and determine the axes of rotation, from which the axle geometry and the steering roll radius can subsequently be determined on the basis of a model.

Stationary wheel alignment systems are described, for example, in EP 1277027 B1 and US2003/0142294. DE 10 2014 113 596 A1 describes a system for compensating for self-steering behavior by incorporating the steering gear, wherein side-selective braking is also provided.

In such systems, a steering roll radius is therefore generally assumed or determined once in order to be able to carry out subsequent steering brake operations.

It has been found that the assumption of a single detected steering roll radius is relatively inaccurate. This means that significant changes to the steering roll radius can occur when other wheels are fitted, so that the subsequent execution of steering brake operations is based on an uncertain foundation.

### SUMMARY

It is an object of the disclosure to provide a method that enables the steering roll radius to be determined reliably. Furthermore, a method for steering braking using this method, a control unit and a commercial vehicle for this purpose are to be created.

The above object is, for example, achieved by a method for determining a steering roll radius of a vehicle. The method includes: during a journey, initiating an asymmetrical braking maneuver on a steered axle of the vehicle, in which a first braking force is applied to a first wheel of the steered axle, which is greater than a second braking force applied to a second wheel of the steered axle; during the asymmetrical braking maneuver, determining a steering command signal input from a driver or a vehicle system; during the asymmetrical braking maneuver, evaluating a steering maneuver caused by the asymmetrical braking maneuver; evaluating the asymmetrical braking maneuver as a function of determined data; and, determining at least a sign of the steering roll radius of at least the first wheel as a function of said evaluating the asymmetrical braking maneuver.

The above object is, for example, also achieved by a method for steering braking using the above method.

The above object is, for example, also achieved by a control unit for carrying out the above methods and a commercial vehicle for this purpose are created.

This means that asymmetrical braking maneuvers of a steered axle of the vehicle are carried out after the vehicle has started moving, in which one wheel of the steered axle is braked more strongly than the other wheel. In this case, the other wheel with weaker braking can also be braked with a braking force of zero, that is, not braked at all, so that only the first wheel is braked. Furthermore, a steering command signal is determined, which reflects a steering command, that is, in particular a steering request of the driver or a steering command from an autonomous system; the determined steering command signal can also be zero in terms of magnitude, that is, no steering command is given.

Furthermore, a steering maneuver caused by the braking maneuver is evaluated. From an evaluation of this data, at least a sign of the steering roll radius of at least one of the steered wheels, in particular both steered wheels, is subsequently determined.

According to an embodiment, the steering maneuver can be evaluated by measuring a generated steering torque, in particular by a steering torque sensor. Alternatively, the steering maneuver can also be evaluated, for example, by determining the generated wheel steering angle and/or the steering wheel angle, for example, by a steering angle meter or, for example, by determining the change in the direction of travel, for example, via a camera or radar.

This already offers a number of advantages: it is possible to determine the current steering roll radius without having to determine geometric dimensions, for example. By determining the steering torque and the steering command signal and, in particular, relating them to each other, the steering maneuvers generated by the asymmetrical braking can be directly assigned to the steering action. If, for example, a steering torque is detected although the driver or—for example, in the case of an autonomous vehicle system—the virtual driver has not entered a steering request, it is possible to conclude that a steering braking maneuver has taken place and the steering roll radius can be determined from this, at least in terms of its sign.

In particular, this makes it possible to determine the sign of the steering roll radius, that is, whether the steering roll radius is positive or negative. It is recognized here that knowledge of this sign is particularly important for subsequent, deliberately initiated steering braking maneuvers, in order to avoid, for example, initiating a steering braking maneuver in the wrong direction. The exact size of the steering roll radius is not quite as important as the sign, as the asymmetrical braking effect can be increased or decreased during a steering braking maneuver, for example. In particular, knowing the sign of the steering roll radius can, for example, rule out the possibility that a positive steering roll radius will lead to an increase in steering, even though a negative steering roll radius has been assumed, which should lead to automatic counter-steering.

On the one hand, the braking forces, that is, the brake pressures in the case of a pressurized braking system, as well as a steering torque and a steering command signal are measured variables that are often already available in vehicle systems and therefore do not require any additional sensor data.

According to an embodiment, the initiation of a first asymmetrical braking maneuver and/or the subsequent asymmetrical braking maneuvers is based on a braking criterion, whereby it can be ensured in particular that the determination is made early enough and/or is sufficiently valid. The braking criterion can include the following evaluations or sub-criteria, among others:

a driving time is compared with a first time limit value. In particular, the time since the start of the journey, that is, in particular since a driving speed other than zero, or the time since the vehicle was switched on, for example, since the ignition was switched on, is used as the driving time. This makes it possible to determine the time at an early stage, before heavy braking and, if necessary, before steering braking maneuvers have to be carried out due to a failure of the steering system.

According to another sub-criterion, a time duration between the end of the last drive and the current start of the drive is evaluated, that is, in particular compared with a limit value. If the duration of time since the end of the last journey exceeds a second time limit value, a current determination of the steering roll radius can be provided, as important properties of the wheel may have changed.

For example, the wheel may have been changed and the rim may thus have been changed at the same time, if necessary, meaning that the wheel offset may have changed.

According to another sub-criterion, a possible wheel change is detected by determining and evaluating a tire inflation pressure and, if a change above a change limit value since the last journey is detected, it is recognized that a wheel change may have occurred and therefore the method is carried out and the steering roll radius is to be redetermined. Alternatively or additionally, an identification number of the tire pressure sensor can also be read out. If the number changes, it is recognized that a wheel change may have occurred, so that the method is then applied.

Another sub-criterion can be the determination of straight-ahead driving. The current wheel steering angle or steering wheel angle can be used for this purpose. For example, the asymmetrical braking maneuver can be carried out while driving straight ahead in order to avoid or minimize critical driving situations.

According to a development, an autonomous compensation steering maneuver is initiated, in particular for full or partial compensation of the steering brake effect, especially when the asymmetrical braking maneuver is initiated autonomously as a test braking maneuver. Here, for example, the current or currently known value of the steering roll radius can be assumed in order to at least reduce the steering brake effect through the autonomous compensation steering. This means that the driver will not notice the asymmetrical braking maneuver or will not notice it to any relevant extent.

According to further developments, subsequent asymmetrical braking maneuvers can be carried out with different braking forces and/or different signs of the difference in the braking forces in order to increase the accuracy. Furthermore or alternatively, braking maneuvers can be carried out on different surfaces and therefore with different friction coefficients.

In the case of pressure-actuated braking systems, the brake pressures in particular can be used as braking forces.

According to a further embodiment, the validity of the determined steering roll radius is determined. For this purpose, a confidence index or confidential index can be determined, which indicates the validity of the evaluation process or evaluation progress. In this way, continuous measurements can be used to increase the accuracy of the steering roll radius measurement and this improvement can be determined. For example, the driver can be shown when the confidential index has reached a relevant value that enables autonomous steering brake operations or can perform them with high accuracy.

Furthermore, the confidential index for an autonomous vehicle system, in particular an autonomous driver assistance system or autonomous safety system, can be used as a deployment criterion so that the steering braking maneuvers are only deployed if they are sufficiently valid.

The steered axle can be the front axle in particular. Furthermore, the steering roll radius of a steered rear axle, for example, can also be evaluated.

According to an embodiment, the temporal behavior of the determined steering command signal and/or the steering torque is evaluated. This improves the accuracy of the determination. In particular, the driver's steering request can be better separated from a steering torque exerted by the asymmetrical braking maneuver based on the steering torque exerted by the driver.

In accordance with the disclosure, a method for steering braking is thus also created in particular, which enables safe steering braking maneuvers even if the steering system fails, and thus increases safety. Due in particular to the determined confidential index, more powerful steering braking maneuvers can also be initiated. For example, the steering braking maneuvers can only be initiated when the confidential index exceeds a limit value, and it can also be provided that the strength of the steering brake maneuvers is dependent on the level of the confidential index.

Furthermore, a control unit is provided which contains instructions for carrying out the method according to the disclosure, as well as a vehicle, in particular a commercial vehicle having the control unit and/or for carrying out the method. The sensor for determining the steering torque can be provided in a conventional manner in the steering shaft; the steering input can be provided, for example, by measuring a steering wheel angle in the vehicle or a steering command signal.

### BRIEF DESCRIPTION OF DRAWINGS

The invention will now be described with reference to the drawings wherein:

FIG. 1 shows a front view of a vehicle;

FIG. 2 shows the vehicle from above during a braking maneuver;

FIG. 3 shows the vehicle from FIG. 2 during a braking and steering maneuver;

FIG. 4 shows a detail enlargement from FIG. 1;

FIG. 5 shows the tire contact areas of the front axle from FIG. 2; and,

FIG. 6 shows a flow chart of a method according to the disclosure.

### DETAILED DESCRIPTION

A commercial vehicle 1 drives on a road surface 2. The commercial vehicle 1 has a steered front axle VA and, according to the embodiment shown here, a rear axle HA; further rear axles, possibly also liftable additional axles or rear axles, can also be provided.

In the following description, elements on the left-hand side of the commercial vehicle 1 are designated by the index-1, and correspondingly elements on the right-hand side of the commercial vehicle 1 are designated by the index-2. Thus, the commercial vehicle 1 has a steerable left front wheel VA-1 and a steerable right front wheel VA-2. A left front wheel brake 4-1 is provided on the left front wheel VA-1, and correspondingly a right front wheel brake 4-2 is provided on the right front wheel VA-2, which can be configured, for example, as pneumatic brakes, in particular pneumatic disk brakes. Correspondingly, rear wheel brakes 5-1 and 5-2 are provided on the wheels HA-1, HA-2 of the rear axle HA.

In the vehicle coordinate system XYZ of vehicle 1 as shown in FIGS. 2 and 3, X denotes the longitudinal direction; correspondingly, Y represents the transverse direction. The different coordinate systems of the road, the vehicle and the individual wheels must be converted into each other accordingly; for the sake of simplicity, the vehicle coordinate system XYZ is considered below. The direction of travel F thus corresponds to the longitudinal direction X in the vehicle coordinate system XYZ when driving straight ahead.

The front wheel brakes 4-1, 4-2 and the rear wheel brakes 5-1, 5-2 are parts of a pneumatic braking system 6, which furthermore includes a brake control unit 8, for example an EBS control unit 8, and a compressed air system with electropneumatic valves, which is not described further here, so that the EBS control unit 8 can control the wheel brakes 4-1, 4-2, 5-1, 5-2 with an individual pneumatic brake pressure P41, P42, P51, P52 by activating the electropneumatic valves.

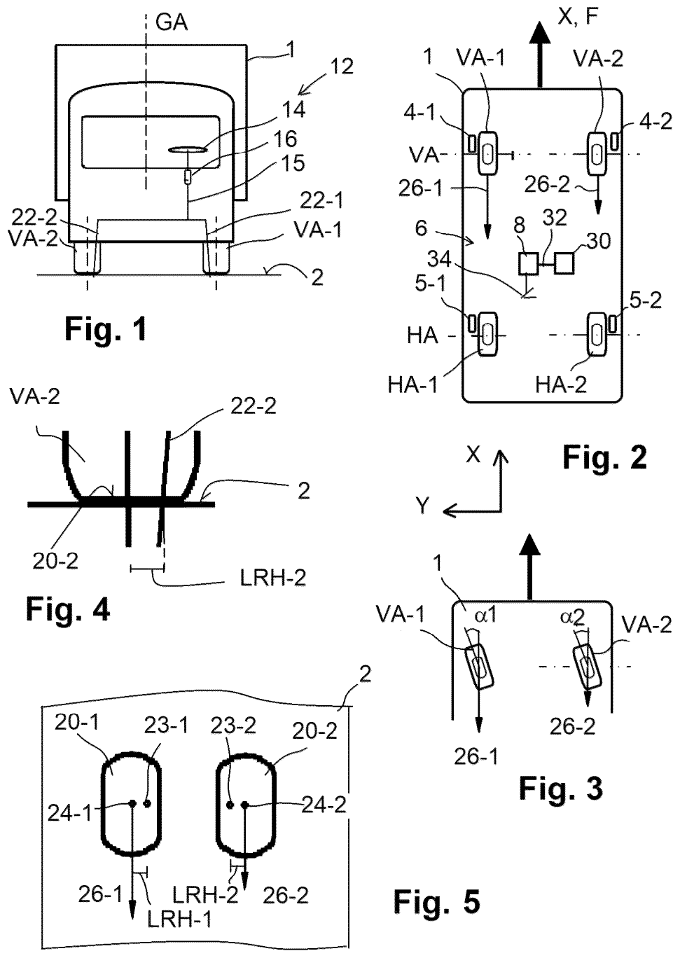

Furthermore, the commercial vehicle 1 has a steering system 12, shown in greater detail in FIGS. 1 and 3, with a steering wheel 14 to be operated by the driver, a steering shaft 15 and, according to this embodiment, a steering torque sensor 16 provided in or on the steering shaft 15. The steering torque sensor 16, which can be formed, for example, via a torsionally soft area of the steering shaft 15. The steering torque sensor 16 is used here to detect the steering maneuver, although the steering maneuver can also be detected in other ways.

The front wheels VA-1, VA-2 stand in tire contact areas 20-1, 20-2 on the road surface 2, which are shown in greater detail in FIG. 5. The left front wheel VA-1 is pivotable about a left pivot axis 22-1, wherein the left pivot axis 22-1 intersects the road surface 2 at an intersection point 23-1 which is offset from a center point 24-1 of the left tire contact area 20-1 by the left steering roll radius LRH-1 in the transverse direction Y.

Accordingly, the right front wheel VA-2 is pivotable about a right pivot axis 22-2, which in turn intersects the road surface 2 at a right intersection point 23-2, which is offset relative to the right center point 24-2 by the right steering roll radius LRH-2 in the transverse direction Y.

In the embodiment shown here, there is a positive steering roll radius LRH-1 and LRH-2, as generally occurs in commercial vehicles 1.

During a braking maneuver, a brake pressure p41 is thus applied by the EBS control unit 8 to the left front wheel brake 4-1 and thus brakes the left front wheel VA-1, so that the left front wheel VA-1 experiences a braking force 26-1 on the road surface 2—against the direction of travel F or longitudinal direction X—which arises from the interaction with the road surface 2, wherein between the left front wheel VA-1 and the road surface 2, as well as slip et cetera, are included in the amount of the left braking force 26-1 in accordance with the friction coefficient parameter or coefficient of friction. Accordingly, a left steering torque LM-1 is exerted on the left front wheel VA-1 from the braking force 26-1 and the left steering roll radius LRH-1, which thus swivels the left front wheel VA-1 and, due to the kinematic coupling, also the right front wheel VA-2. If the front axle A is configured as a rigid axle, this results in a sum of the steering torques LM-1 and LM-2 as the total steering torque LM.

FIG. 2 shows straight-ahead travel; in FIG. 3 the front wheels are turned accordingly, that is, wheel steering angles alpha-1, alpha-2 are not equal to zero.

In the embodiment shown, there is an electronic or electrically controlled steering system with a steering control unit 30, which is connected to the EBS control unit 8, for example via a CAN bus 32. The steering control unit 30 enables independent steering to be initiated on both the left front wheel VA-1 and the right front wheel VA-2.

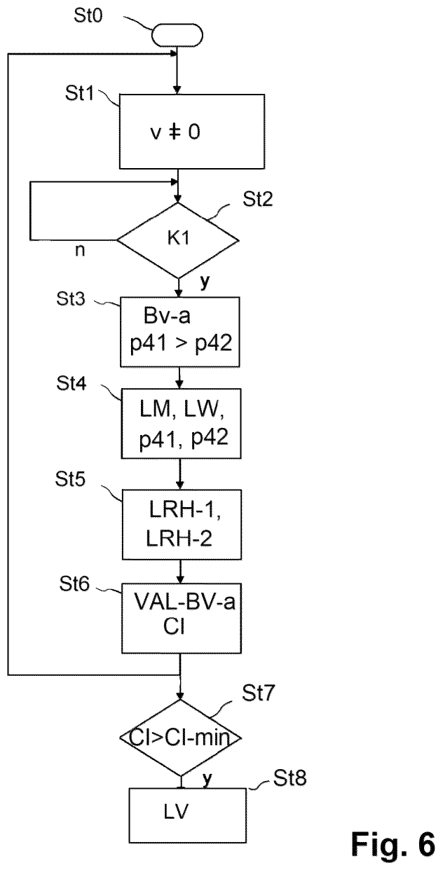

According to FIG. 6, a method according to the disclosure has at least the following steps: The method is started in step St0, in the above-described commercial vehicle 1 and its above-mentioned features. The commercial vehicle 1 then begins its journey in accordance with step St1, that is, driving speed v is not equal to 0 (forward or reverse travel). After starting to drive, the commercial vehicle 1 initially drives straight ahead at its driving speed v, for example, so that the direction of travel F corresponds to the longitudinal direction X.

In step St2, St3, the first asymmetrical braking maneuver BV-a is initiated. The first braking maneuver BV-a can, for example, take place during a first automatic braking of the commercial vehicle 1, which is initiated via the EBS control unit 8 in response to a driver request, that is, actuation of a brake pedal 34. Furthermore, as shown in FIG. 6, a braking criterion K1 can be provided in step St2 for the automatic initiation of braking by the EBS control unit 8. The braking criterion K1 can detect several sub-criteria, e.g:

driver braking or other braking has not yet been initiated, nor has the EBS control unit 8 automatically initiated the first braking maneuver BV-a, for example due to instability.

Furthermore, it can be included as a sub-criterion that the first asymmetrical braking maneuver BV-a is initiated when driving straight ahead without lateral dynamics and/or without road inclination, that is, the direction of travel F corresponds to the longitudinal direction X of the vehicle 1 and the wheel steering angles alpha-1, alpha-2 equal zero.

Alternatively, however, cornering can also be provided, that is, with steering torque LM≠0.

Furthermore, a tire inflation pressure signal S2 can be used, in particular the temporal behavior of the tire pressure signal S2, in order to detect a change in the determined tire pressure at the start of the journey, that there was a high probability of a tire change, so that the braking criterion K1 is fulfilled in order to measure a new tire or a new wheel VA-1 or VA-2 if necessary.

Furthermore, the time duration t1 since the start of the journey or the time duration since “ignition on” or switching on of the commercial vehicle 1 can be evaluated as a sub-criterion, so that the first asymmetrical braking maneuver BV-a is initiated within a sufficiently short period of time after the start of the journey or switching on of the commercial vehicle 1.

Furthermore, it can also be included as a sub-criterion that a sufficiently long period of time t>delta-t2 has elapsed after the end of the last journey and the start of the new journey; if the vehicle stops briefly, for example, the method does not have to be carried out again immediately.

Further sub-criteria of braking criterion K1 can be that:
the first asymmetrical braking maneuver is to be carried out below a limit speed v-lim of, for example, 30 km/h, that is, v<v-lim;
there is no yawing movement of the vehicle about its vertical axis GA, and/or there is no rolling movement or lateral buckling of the commercial vehicle 1 on an inclined road surface 2, for example.

If the braking criterion K1 is fulfilled, the first asymmetrical braking maneuver BV-a is initiated according to step St3, in which one of the wheels VA-1, VA-2 is braked more strongly than the other wheel. In the embodiment described here, the left front wheel VA-1 is braked more strongly via the left front wheel brake 4-1 than the right front wheel VA-2 via the right front wheel brake 4-2, that is, the left braking force 26-1 is greater than the right braking force 26-2, that is, for example, the left braking pressure p41 is greater than the right braking pressure p42.

During the braking maneuver BV-a, data is recorded in accordance with step St4, in particular the measured steering torque LM, the steering command signal LW, and also data on the braking maneuver initiated, that is, on the braking forces 26-1, 26-2. For example, the braking pressures p41, p42 applied can be used for this purpose.

In step St5, the collected data is evaluated. This determines whether a steering maneuver can be detected and, if necessary, the steering maneuver performed is evaluated. According to an embodiment, the steering torque LM generated by the driver can be detected if the driver counteracts the initiated steering action. Furthermore or alternatively, the steering action generated can also be determined as a change in steering wheel angle if the driver does not counter-hold or only partially counter-holds. The direction in which the vehicle is pulling can therefore also be measured; the wheel steering angle can also be recorded quantitatively, wherein it is generally sufficient to determine the direction. According to a further embodiment, the applied brake pressures can be related to the resulting wheel steering angle.

If, for example, the driver does not currently enter a steering request via the steering wheel 14 and the intention is therefore to drive straight ahead, the determined steering torque LM can be assigned directly to the asymmetrical braking of the front wheels VA-1, VA-2, that is, as a steer-by-brake effect.

Thus, in step St5, at least the sign of the left and right steering roll radius LRH-1, LRH-2 can be determined from the determined steering torque.

If the braking maneuver BV-a has been initiated autonomously, that is as a test braking, the steering braking maneuver can be fully or partially compensated in step St3 by an active steering intervention, in which the steering control unit 30 thus initiates an active steering maneuver which compensates for the detected steering torque LM, so that the vehicle 1 is not steered or is not steered in a relevant manner and thus does not change its direction of travel F. The compensation steering maneuver can thus be calculated and initiated from the detected steering torque and/or from a measured yaw rate omega.

According to step St6, before and during the first braking maneuver BV-a, validity data VAL-BV-a is collected, which is used to determine a confidential index CI. One or more of the following data items are recorded as validity data VAL-BV-a:

a current steering torque LM (t), the left front wheel brake pressure P41 and right front wheel brake pressure P42, for example, temperature Tp and, for example, a determined current adhesion value HW-1, HW-2, furthermore, for example, determined data on the road gradient, the driving direction F, the driving speed V, the wheel steering angles alpha-1, alpha-2 of the front wheels VA-1, VA-2. The validity of the evaluation of the first braking maneuver BV-a is thus evaluated from these data.

Furthermore, a longitudinal acceleration can be determined as part of the VAL-BV-a validity data, using a longitudinal acceleration sensor or, for example, as a time derivative of the driving speed v.

Advantageously, several braking maneuvers BV-a and subsequently BV-b, BV-c, . . . are carried out in order to obtain precise data for the determination. The brake pressures P41, P42 can be varied, wherein in particular, for example, the difference or the sign of the difference between the brake pressures P41, P42 is changed; thus, for example, a higher right front wheel brake pressure P42 than the left front wheel brake pressure P41 is entered in the subsequent braking maneuver BV-b.

But even during non-ideal driving situations, that is, when cornering, the steering roll radii LRH-1, LRH-2 can be inferred, taking into account the other effects.

Initially, the steering roll radii LRH-1 and LRH-2 can be assumed to be the same. During further determination, these can be determined individually and therefore differently.

As the first braking maneuver BV-a is sufficiently small, a sufficient first determination can already be achieved—with initially unknown steering roll radii LRH-1, LRH-2—which can be set correspondingly more precisely for subsequent braking maneuvers BV-b, BV-c, . . . , that is, the validity or a confidential index CI indicating the validity increases and later reaches a limit value CI-min, which indicates sufficient safety, so that automatic steering braking maneuvers can be initiated.

Thus, in a step St7 it can be checked whether the CI is sufficiently large, and when the limit value CI-min is reached, it can be decided that steering braking maneuvers LV can be initiated, as indicated in step St8.

If the steering control unit 30 thus detects a complete or partial defect in the steering system 12, the steering control unit 30 informs the EBS control unit 8 of this via the CAN bus 32, so that it is subsequently checked, for example, whether the confidential index CI is large enough for SBB operations to be initiated, so that the EBS control unit 8 initiates steer-by-brake SBB operations. Advantageously, additional information about the sign of the steering roll radius is transmitted or used so that the EBS control unit 8 can then react with a targeted control.

The coordination between the brake control unit 8 and the steering control unit 30 can originate from either of the two control units 8, 30. A higher-level control unit can also be provided for the method, which thus controls the two control units 8, 32 in a subsidiary manner.

A learning phase LPH is thus carried out, from the start with t=0 to, for example, the determination of a limit value of the confidential index CI-min. When CI-min is reached, it is thus recognized that steer-by-brake is possible. This can be indicated to the driver by a display signal S1, so that the driver can adjust his driving behavior and in particular his steering behavior or active steering.

In particular, the steer-by-brake can be used by the EBS control unit 8 in one or more of the following driving dynamics control and/or driver assistance systems: ABS (anti-lock braking system), EBS (electronic braking system), ESP (electronic stability program), FDR (vehicle dynamics control), ACC (automatic cruise control).

The SBB processes described here therefore occur in particular by changing the wheel steering angle alpha-1, alpha-2 in FIG. 3. It should also be noted that a brake-steering effect also occurs on the unsteered axle HA and also additionally on the steered axle VA as a result of the asymmetrical braking BV-a as such, even without changing the wheel steering angle alpha-1, alpha-2. Asymmetrical braking of the rear axle HA can therefore be included.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 commercial vehicle
2 road surface
VA front axle
VA-1 left front wheel
VA-2 right front wheel
HA rear axle
HA-1 left rear wheel
HA-2 right rear wheel
4-1 left front-wheel brake
4-2 right front-wheel brake
5-1 left rear-wheel brake
5-2 right rear-wheel brake
6 pneumatic braking system, in particular EBS
8 brake control unit
10 compressed air system
11 electropneumatic valves
12 steering system
14 steering wheel
15 steering shaft
16 steering torque sensor
17 steering wheel angle sensor
20-1 left tire contact area
20-2 right tire contact area
22-1 left pivot axis
22-2 right pivot axis
23-1 left intersection
23-2 right intersection
24-1 left center of the left tire contact area 20-1
24-2 right center of the right tire contact area 20-2
26 tire pressure sensor
26-1 left braking force acting on the left front wheel VA-1
26-2 right braking force acting on the right front wheel VA-2
30 steering control unit
32 CAN bus
34 brake pedal
43 longitudinal acceleration sensor
45 vehicle system, in particular autonomous or semi-autonomous vehicle system
45a autonomous or semi-autonomous driving dynamics controls
45 autonomous or semi-autonomous driver assistance system
46 pre-stored values for the compensation steering torque (LM-K)
alpha-1 and alpha-2 wheel steering angle
B1 first condition of termination criterion K3
B2 second condition of termination criterion K3
BV-a first braking maneuver
CI confidential index
CI-1 minimum confidential index
delta-t first period
F direction of travel
GA vertical axis
HW-1, HW-2 current adhesive value
K1 braking criterion
K2 deployment criterion
K3 cancellation criterion
LM-K compensation steering torque
LRW steering wheel angle
LRH-1 left steering roll radius of the left front wheel V-1
LRH-2 right steering roll radius of the right front wheel V-2
LM-1 left steering torque
LM-2 right steering torque
LM (t) current steering torque
LPH learning phase
LV autonomous steering brake operations
S1 steering torque signal
S2 tire pressure signal
S3 brake signal
S4 autonomous steering signal
Delta-S2 temporal change of the tire pressure signal S2
sgn (LRH-1), sgn (LRH-2) sign of the steering roll radius LRH-1, LRH-2
P41 brake pressure in the left front wheel 4-1
P42 brake pressure in the right front wheel 4-2
Delta-P difference between the first and second braking force (P41, P42)
V-LRH validity of the determined steering roll radius
G-LRH accuracy of the determined steering roll radius
G-LV accuracy of steering brake maneuvers LV
t1 duration of the journey
t2 period since last journey
t-lim-1
t-lim-2
Tp temperature
S5 display signal
S6 enable signal (6) for autonomous steering brake maneuvers (LV)
V driving speed
VAL-BV-a validity data
v-lim speed limit value
XL longitudinal direction (not direction of travel, correct this)
Y transverse direction of the commercial vehicle 1
Z vertical direction, upward direction of the commercial vehicle 1

1. A method for determining a steering roll radius of a vehicle, the method comprising:
during a journey, initiating an asymmetrical braking maneuver on a steered axle of the vehicle, in which a first braking force is applied to a first wheel of the steered axle, which is greater than a second braking force applied to a second wheel of the steered axle;
during the asymmetrical braking maneuver, determining a steering command signal input from a driver or a vehicle system;
during the asymmetrical braking maneuver, evaluating a steering maneuver caused by the asymmetrical braking maneuver;
evaluating the asymmetrical braking maneuver as a function of determined data; and,
determining at least a sign of the steering roll radius of at least the first wheel as a function of said evaluating the asymmetrical braking maneuver.

2. The method of claim 1, wherein at least one of a following is carried out when evaluating the steering maneuver caused by the asymmetrical braking maneuver:
determining and evaluating a steering torque exerted on the wheels of the steered axle;
determining and evaluating at least one resulting wheel steering angle of the wheels of the steered axle; and,
determining and evaluating a change in a direction of travel of the vehicle.

3. The method of claim 1, wherein a temporal behavior of at least one of the steering command signal, the steering maneuver, a steering torque, and a change of direction is evaluated.

4. The method of claim 1, wherein after a determining of the journey, a braking criterion is checked, and if the braking criterion is fulfilled, the asymmetrical braking maneuver is initiated on the steered axle.

5. The method of claim 4, wherein the braking criterion includes at least one of a plurality of sub-criteria including:
comparison of a journey duration since a start of the journey with a first time limit value;
comparison of a time period between a last journey and the start of the journey with a second time limit value;
evaluation of at least one tire inflation pressure signal; and,
determination of straight-ahead travel.

6. The method of claim 4, wherein the braking criterion includes at least one of a plurality of sub-criteria including:
comparison of a journey duration since a start of the journey with a first time limit value;
comparison of a time period between a last journey and the start of the journey with a second time limit value;
evaluation of a change over time of at least one tire pressure signal of the first wheel or of the second wheel since the last journey; and,
determination of straight-ahead travel.

7. The method of claim 1, wherein at least one of a steering wheel angle and a target steering torque, which is specified by at least one of a driver and a vehicle system, is applied as the steering command signal.

8. The method of claim 2, wherein, when the asymmetrical braking maneuver is initiated autonomously without a steering command signal, a compensation steering torque is input for at least partial or complete compensation of the determined steering torque.

9. The method of claim 8, wherein the compensation steering torque is determined as a function of at least one of pre-stored values and a previously determined steering roll radius.

10. The method of claim 1, wherein the asymmetrical braking maneuver is a first asymmetrical braking maneuver; and, the first asymmetrical braking maneuver is carried out with smaller braking forces than subsequent asymmetrical braking maneuvers, and/or the braking forces of the first asymmetrical braking maneuver are below a limit braking force.

11. The method of claim 1, wherein at least two asymmetrical braking maneuvers with different signs of the difference of the first braking force and second braking force are carried out.

12. The method of claim 1, wherein validity data are recorded before or during the evaluation of the asymmetrical braking maneuver and a confidential index is created as a function of the validity data and represents a validity or accuracy of the determined steering roll radius and/or reflects an evaluation of accuracy of subsequent steering braking maneuvers.

13. The method of claim 12, wherein the confidential index is compared with a limit value and, when the limit value is reached, at least one of a display signal and an enable signal for autonomous steer-by-braking maneuvers is set.

14. The method of claim 1, wherein, during at least one of the asymmetrical braking maneuver and a subsequent asymmetrical braking maneuver, at least one further axle of the vehicle is braked asymmetrically in addition to the at least one steered axle.

15. The method of claim 1, wherein the initiation of the asymmetrical braking maneuver on the at least one steered axle is terminated when a termination criterion is fulfilled; and, the termination criterion is fulfilled in a case of at least one of:
a sign of the steering roll radius is determined; and,
a safety-critical driving situation is detected.

16. A method for steering-braking a commercial vehicle, the method comprising:
determining a steering roll radius;
initiating a steering braking maneuver as a function of the determined steering roll radius, in which the vehicle is steered by asymmetrical application of wheel brakes at least of a steered axle;
wherein said determining a steering roll radius includes:
during a journey, initiating an asymmetrical braking maneuver on the steered axle of the vehicle, in which a first braking force is applied to a first wheel of the steered axle, which is greater than a second braking force applied to a second wheel of the steered axle;
during the asymmetrical braking maneuver, determining a steering command signal input from a driver or a vehicle system;
during the asymmetrical braking maneuver, evaluating a steering maneuver caused by the asymmetrical braking maneuver;
evaluating the asymmetrical braking maneuver as a function of determined data; and,
determining at least a sign of the steering roll radius of at least the first wheel as a function of said evaluating the asymmetrical braking maneuver.

17. The method of claim 16, wherein the steering braking maneuver is initiated as a function of a determined confidential index.

18. The method of claim 16, wherein the steering braking maneuver is initiated as a function of a determined confidential index when a limit value is reached.

19. The method of claim 16, wherein the method is performed during an autonomous driving dynamics control and/or an autonomous driver assistance system.

20. The method of claim 19, wherein the autonomous dynamics control and/or the autonomous driver assistance system is at least one of an anti-lock braking system, an electronic braking system, an electronic stability program, a vehicle dynamics control, and an automatic cruise control.

21. The method of claim 18, wherein the steering braking maneuver is only initiated if the determined confidential index exceeds a limit value.

22. A control unit of a vehicle, the control unit comprising:
a non-transitory computer readable storage medium having program code stored thereon;
a processor;
said program code being configured, when executed by said processor, to:
during a journey, initiate an asymmetrical braking maneuver on a steered axle of the vehicle, in which a first braking force is applied to a first wheel of the steered axle, which is greater than a second braking force applied to a second wheel of the steered axle;
during the asymmetrical braking maneuver, determine a steering command signal input from a driver or a vehicle system;
during the asymmetrical braking maneuver, evaluate a steering maneuver caused by the asymmetrical braking maneuver;
evaluate the asymmetrical braking maneuver as a function of determined data; and,
determine at least a sign of a steering roll radius of at least the first wheel as a function of the evaluating the asymmetrical braking maneuver.

23. A vehicle comprising:
at least one steered axle with a first steered wheel and a second steered wheel;
at least one further axle;
a braking system including a plurality of wheel brakes provided on the first and second steered wheels of the steered axle and the further axle and a brake control unit;
a steering system having at least one of a steering torque sensor for detecting a steering torque and a steering wheel angle sensor for detecting a steering wheel angle;
the steering system further having a steering control unit; and,
wherein at least one of the brake control unit and the steering control unit is configured as a control unit including a processor and a non-transitory computer readable storage medium having program code stored thereon;
the program code being configured, when executed by said processor, to:
during a journey, initiate an asymmetrical braking maneuver on the steered axle of the vehicle, in which a first braking force is applied to the first wheel of the steered axle, which is greater than a second braking force applied to the second wheel of the steered axle;
during the asymmetrical braking maneuver, determine a steering command signal input from a driver or a vehicle system;
during the asymmetrical braking maneuver, evaluate a steering maneuver caused by the asymmetrical braking maneuver;
evaluate the asymmetrical braking maneuver as a function of determined data; and,
determine at least a sign of a steering roll radius of at least the first wheel as a function of the evaluating the asymmetrical braking maneuver.

24. The vehicle of claim 23, wherein the vehicle is a commercial vehicle.
